(19) United States
(12) Patent Application Publication
(10) Pub. No.: US 2024/0213922 A1
(43) Pub. Date: Jun. 27, 2024

(54) METHOD OF ESTIMATING PHOTOVOLTAIC MODEL PARAMETERS AND DATA-BASED PHOTOVOLTAIC FAULT DETECTION AND DIAGNOSIS METHOD AND APPARATUS USING PHOTOVOLTAIC MODEL

(71) Applicant: POSTECH Research and Business Development Foundation, Pohang-si (KR)

(72) Inventors: Young Jin KIM, Pohang-si (KR); Ji Hun HA, Pohang-si (KR)

(73) Assignee: POSTECH Research and Business Development Foundation, Pohang-si (KR)

(21) Appl. No.: 18/089,932

(22) Filed: Dec. 28, 2022

(30) Foreign Application Priority Data
Dec. 27, 2022 (KR) 10-2022-0185206

(51) Int. Cl. H02S 50/10

(52) U.S. Cl. CPC H02S 50/10

(57) ABSTRACT

Disclosed are a method of estimating PV model parameters and a method and an apparatus for data-based PV fault detection and diagnosis using a PV model. The method comprises: substituting five parameters of a PV current, a diode saturation current, a diode ideality factor, a series resistance, and a parallel resistance into an output equation of a single diode model for PV modeling of a PV module; computing an MAEP in an output by comparing power-voltage (P-V) curve values of the PV module obtained from the single diode model, which is a PV simulation model, and P-V curve values of the PV module, which is an actual PV module, when the voltage is zero, the open-circuit voltage, or a specific data value increased as much as a preset intensity; and selecting parameters representing a minimum MAEP among a plurality of stored MAEPs as parameters of the PV simulation model.

### CROSS-REFERENCE TO RELATED APPLICATIONS

This application claims priority to Korean Patent Application No. 2022-0185206 filed on Dec. 27, 2022 in the Korean Intellectual Property Office (KIPO), the entire contents of which are hereby incorporated by reference.

### BACKGROUND

### 1. Technical Field

Example embodiments of the present invention relate to a method of estimating photovoltaic (PV) model parameters, and a data-based PV fault detection and diagnosis method and apparatus using a PV model.

### 2. Related Art

As the keywords such as climate change and carbon neutrality become more important worldwide, interest in renewable energy sources is also steadily increasing. Photovoltaic (PV) systems are particularly widely used as renewable energy sources due to desirable advantages such as eco-friendly operation and low installation and maintenance costs. Looking the global cumulative installed capacity of the PV systems, it has increased about 17 times in 2020 as compared to 2010.

However, since the PV system is installed outdoors, various failures or abnormal states such as a line-to-line fault (LLF), an open circuit fault (OCF), a partial shading fault (PSF), and a degradation fault (DF) are easily caused. When a fault occurs in the PV system and is not immediately detected, a fire may occur. In addition, 18.9% power loss occurs annually in photovoltaic power generators due to various defects. Many fault detection and diagnosis (FDD) algorithms have been developed to prevent such a problem in advance.

As listed in Table 1, PV fault diagnosis algorithms are being actively studied. Threshold-based diagnosis algorithms, on which many studies have been conducted from the past to the present, require a long time and high expertise to set or understand thresholds. That is, in order to detect PV faults, efforts are required to manually extract features of each fault. A method using a fuzzy logic classifier [1], a method using maximum power point tracking (MPPT) [2], and a method using a voltage sensor [3] are known as threshold computation methods.

In addition, machine learning (ML)-based fault diagnosis methods, which manually extract features in the same way as the threshold-based method but additionally train a data-based fault diagnosis model to classify faults, have also been widely studied. [4] Support Vector Machine (SVM), [5] Graph-based semi-supervised learning (GBSSL), and [6] k-nearest neighbor (kNN) are known as the ML-based methods. These methods generate data-based models but have to be trained by manually extracting defect features.

The above-described related art is summarized in Table 1 below.

TABLE 1

| Base | | | (b) Detected fault types | | | |
|---|---|---|---|---|---|---|
| method | Ref. | (a) Detection variables | LLF/LLWRF | OCF | RSF | DF |
| ML-based | Proposed | I-V Curve | ◯/◯ | ◯ | ◯ | ◯ |
| Threshold- | [1] | I-V Curve | X/X | X | ◯ | ◯ |
| based | [2] | I-V Curve | ◯/X | ◯ | ◯ | X |
| | [3] | V_{MPP}, I_{MPP}, V_{OC}, I_{SC} | ◯/X | ◯ | ◯ | X |
| ML-based | [4] | I-V Curve | ◯/◯ | X | ◯ | ◯ |
| | [5] | V_{MPP}, I_{MPP}, V_{OC}, I_{SC} | ◯/◯ | ◯ | ◯ | X |
| | [6] | V_{MPP}, I_{MPP}, V_{OC}, I_{SC} | ◯/X | ◯ | ◯ | X |

In Table 1, V_{MPP} denotes a voltage at a maximum power point, I_{MPP} denotes a current at the maximum power point, V_{OC} denotes an open-circuit voltage, and I_{SC} denotes a short circuit voltage. In addition, LLF denotes a line-to-line fault, LLWRF denotes a line-to-line with resistance fault, OCF denotes an open circuit fault, PSF denotes a partial shading failure, and DF denotes a degradation fault.

In addition, as can be seen in Table 1, conventional studies [1] to [6] have a common feature for detecting or diagnosing only some types of PV faults. Some fault types such as an LLF, a PSF, and a DF have similar properties under certain climatic conditions, such as a temperature and a solar radiation amount, and thus some of the fault types are difficult to detect. In addition, it is not easy to distinguish PV faults having similar properties even using detection parameters used in the above-described conventional studies.

### SUMMARY

Accordingly, example embodiments of the present invention are provided to substantially obviate one or more problems due to limitations and disadvantages of the related art. Example embodiments of the present invention provide a method of estimating photovoltaic (PV) model parameters that is capable of actively and efficiently detecting and diagnosing PV faults by generating a simulation model through PV model parameter estimation to form a DenseNet-based PV fault diagnosis model using the simulation model instead of manually extracting defect features when diagnosing a fault of a PV system using a deep neural network method, and a data-based PV fault detection and diagnosis method and apparatus using the simulation model using the same.

Example embodiments of the present invention provide a PV hybrid unknown parameter estimation method that may be used to generate an accurate PV simulation model for determining the presence or absence of a PV fault and a simplified DenseNet-based fault detection and diagnosis algorithm using the same.

According to a first exemplary embodiment of the present disclosure, a method of estimating photovoltaic (PV) model parameters that is performed by a processor may comprise: substituting five parameters of a PV current, a diode saturation current, a diode ideality factor, a series resistance, and a parallel resistance into an output equation of a single diode model for PV modeling of a PV module; stepwise increasing and applying a voltage of the output equation as much as a preset intensity from 0 to an open-circuit voltage; computing a mean absolute error in power (MAEP) in an output by comparing power-voltage (P-V) curve values of the PV module obtained from the single diode model, which is a PV simulation model, and P-V curve values of the PV module, which is an actual PV module, when the voltage is zero, the open-circuit voltage, or a specific data value increased as much as a preset intensity; and selecting parameters representing a minimum MAEP among a plurality of stored MAEPs as parameters of the PV simulation model.

In the substituting of the five parameters, an initial value of the diode ideality factor may be set to 1, an initial value of the series resistance may be set to 0.001, and an initial value of the parallel resistance may be set to 1.

The method may further comprise computing a maximum power point current and a diode saturation current from the output equation of the single diode model using data values of an open-circuit voltage, a maximum power point voltage, and a maximum power point current given in a datasheet of the PV module.

The method may further comprise computing a non-linear equation of the single diode model on the basis of the series resistance and the parallel resistance using the computed data value of the diode saturation current.

In the computing of the MAEP, a plurality of MAEPs may be computed by stepwise increasing the diode ideality factor, which is initially set to a first value, up to a second value as much as a predetermined magnitude according to the increase in the voltage, and stored.

The first value may be 1, and the second value may be 2.5.

According to a second exemplary embodiment of the present disclosure, a data-based photovoltaic (PV) fault detection and diagnosis apparatus using a PV model may comprise: a data preprocessing unit configured to receive actual current-voltage (I-V) characteristic curve data according to a solar radiation amount and a temperature of a real PV array, and receive simulated I-V characteristic curve data obtained by inputting the solar radiation amount and the temperature into a simulation model in which five parameters required for analysis of an equivalent electrical circuit of a single diode model for modeling the real PV array are reflected; and a detection model configured to process a data set input from the data preprocessing unit according to a predetermined training process to detect a type of a fault of the real PV array, wherein the data preprocessing unit classifies training data, which is a portion of mixed data obtained by mixing the actual I-V characteristic curve data and the simulated I-V characteristic curve data, into a validation set and a training set according to a preset ratio and provides the validation set and the training data to the detection model.

The data preprocessing unit may include a data mixing and splitting unit, wherein the data mixing and splitting unit mixes the actual I-V characteristic curve data with the simulated I-V characteristic curve data, splits the mixed data into training data and test data, and splits the training data into a validation set for the detection model and a training set for the detection model.

The apparatus may further comprise a parameter estimation unit configured to provide the five parameters to the simulation model, wherein the parameter estimation unit is configured to perform: substituting five parameters of a PV current, a diode saturation current, a diode ideality factor, a series resistance, and a parallel resistance into an output equation of a single diode model for PV modeling of a PV module; stepwise increasing a voltage of the output equation as much as a preset intensity from 0 to an open-circuit voltage; computing a mean absolute error in power (MAEP) in an output by comparing power-voltage (P-V) curve values of the PV module obtained from the single diode model, which is a PV simulation model, and P-V curve values of the PV module, which is an actual PV module, when the voltage is zero, the open-circuit voltage, or a specific data value increased as much as a preset intensity; and selecting parameters representing a minimum MAEP among a plurality of stored MAEPs as parameters of the PV simulation model.

In the substituting of the five parameters, the parameter estimation unit may set an initial value of the diode ideality factor to 1, set an initial value of the series resistance to 0.001, and set an initial value of the parallel resistance to 1.

The parameter estimation unit may be configured to further perform computing a maximum power point current and a diode saturation current from the output equation of the single diode model using data values of an open-circuit voltage, a maximum power point voltage, and a maximum power point current given in a datasheet of the PV module.

The parameter estimation unit may be configured to further perform computing a non-linear equation of the single diode model on the basis of the series resistance and the parallel resistance using the computed data value of the diode saturation current.

The parameter estimation unit may be configured to compute and store a plurality of MAEPs by stepwise increasing the diode ideality factor, which is initially set to a first value, up to a second value as much as a predetermined magnitude according to the increase of the voltage in the computing of the MAEP.

The first value may be 1, and the second value may be 2.5.

The training process may include: performing a forward propagation calculation of computing and storing the training set in a forward direction along a neural network of various layers; computing accuracy by inputting data of the validation set to a DenseNet model to which parameters obtained through the forward propagation calculation are applied; and storing parameters or settings in a current DenseNet model when the accuracy is further improved.

The training process may further include computing a preset index when the accuracy is not improved, wherein the index includes at least one of cross entropy loss, binary entropy loss, and log loss.

The training process may further include updating a weight with a preset value, performing the forward propagation calculation up to a preset maximum number of iterations, computing the accuracy, and storing parameters or settings according to a result of the determination of the accuracy or iterating the computing of the preset index.

According to a third exemplary embodiment of the present disclosure, a data-based photovoltaic (PV) fault detection and diagnosis method using a PV model may comprise: receiving actual current-voltage (I-V) characteristic curve data according to a solar radiation amount and a temperature of a real PV array; receiving data values of five parameters used in an equivalent electrical circuit of a single diode model obtained by modeling the real PV array; generating simulated I-V characteristic curve data by inputting the solar radiation amount and the temperature to a simulation model to which the data values of the five parameters are reflected; mixing the actual I-V characteristic curve data and the simulated I-V characteristic curve data, splitting the mixed data into training data and test data, and splitting the training data into a validation set for a detection model and a training set for the detection model; and detecting a fault type of the real PV array by processing the training set and the validation set according to a predetermined training process.

The method may further comprise estimating the parameters, wherein the estimating of the parameters includes: substituting five parameters of a PV current, a diode saturation current, a diode ideality factor, a series resistance, and a parallel resistance into an output equation of a single diode model for PV modeling of a PV module; stepwise increasing a voltage of the output equation as much as a preset intensity from 0 to an open-circuit voltage; computing a mean absolute error in power (MAEP) in an output by comparing power-voltage (P-V) curve values of the PV module obtained from the single diode model, which is a PV simulation model, and P-V curve values of the PV module, which is an actual PV module, when the voltage is zero, the open-circuit voltage, or a specific data value increased as much as a preset intensity; and selecting parameters representing a minimum MAEP among a plurality of stored MAEPs as parameters of the PV simulation model.

In the substituting of the five parameters, an initial value of the diode ideality factor may be set to 1, an initial value of the series resistance may be set to 0.001, and an initial value of the parallel resistance may be set to 1, and the method may further comprise: computing a maximum power point current and a diode saturation current from the output equation of the single diode model using data values of an open-circuit voltage, a maximum power point voltage, and a maximum power point current given in a datasheet of the PV module; and computing a non-linear equation of the single diode model on the basis of the series resistance and the parallel resistance using the computed data value of the diode saturation current, and in the computing of the MAEP, a plurality of MAEPs are computed by stepwise increasing the diode ideality factor, which is initially set to a first value, up to a second value as much as a predetermined magnitude according to the increase of the voltage, and stored.

### BRIEF DESCRIPTION OF DRAWINGS

FIG. 1 is a diagram illustrating a photovoltaic (PV) module, which may be applied to a method of estimating PV model parameters, and an electrical equivalent circuit thereof according to one example embodiment of the present disclosure.

FIG. 2 is a flowchart for describing Villalva's method of a comparative example.

FIG. 3 is a flowchart illustrating a method of estimating PV model parameters according to one example embodiment of the present disclosure.

FIG. 4 is a graph showing a comparison between the method (Proposed) of the present example embodiment and the Villalva's method (Villalva) of the comparative example through the I-V characteristic curve of the PV module.

FIG. 5 is a graph showing a comparison between the method (Proposed) of the present example embodiment and the Villalva's method (Villalva) of the comparative example through the P-V characteristic curve of the PV module.

FIG. 6 is a graph showing a comparison between I-V characteristic curves according to the method (Proposed) of the present example embodiment at different solar radiation amounts and actual values of the datasheet.

FIG. 7 is a graph showing a comparison between P-V characteristic curves according to the method (Proposed) of the present example embodiment at different solar radiation amounts and actual values of the datasheet.

FIG. 8 is a graph showing a comparison between I-V characteristic curves according to the method (Proposed) of the present example embodiment at different temperatures and actual values of the datasheet.

FIG. 9 is a graph showing a comparison between P-V characteristic curves according to the method (Proposed) of the present example embodiment at different temperatures and actual values of the datasheet.

FIG. 10 is a schematic diagram for describing a configuration of a data-based PV fault detection and diagnosis apparatus (hereinafter, simply referred to as a “fault detection apparatus”) using a PV simulation model according to another example embodiment of the present disclosure.

FIG. 11 is a schematic diagram for describing a configuration of a 5×3 PV array testbed of a Matlab/Simulink simulation model, to which the fault detection method of the present example embodiment of FIG. 10 may be applied, and fault types thereof.

FIG. 12 is a graph of I-V characteristic curves for describing fault types that may be considered in the fault detection method of the present example embodiment of FIG. 10.

FIG. 13 is a graph of P-V characteristic curves for describing fault types that may be considered in the fault detection method of the present example embodiment of FIG. 10.

FIG. 14 is a graph for describing a data preprocessing process that may be applied to the fault detection method of the present example embodiment of FIG. 10.

FIG. 15 is a schematic configuration diagram for describing a simplified DenseNet (S_DenseNet) model that may be applied to the fault detection method of the present example embodiment of FIG. 10.

FIG. 16 is a flowchart for a training process of the simplified DenseNet model of FIG. 15.

FIG. 17 is a diagram for describing test data that may be applied to the fault detection method of the present example embodiment of FIG. 10.

FIG. 18 is a diagram for describing an effect of unmixed test data, which may be considered in the fault detection method of the present example embodiment of FIG. 10.

FIG. 19 is a graph illustrating accuracy according to the training number (epoch) of the S_DenseNet model of FIG. 15.

FIG. 20 is a graph illustrating losses according to the training number (epoch) of the S_DenseNet model of FIG. 15.

FIG. 21 is a diagram illustrating a confusion matrix of the simplified DenseNet model for the test set.

FIG. 22 is a schematic block diagram of a data-based PV fault detection and diagnosis apparatus using a PV model according to still another example embodiment of the present disclosure.

### DETAILED DESCRIPTION

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

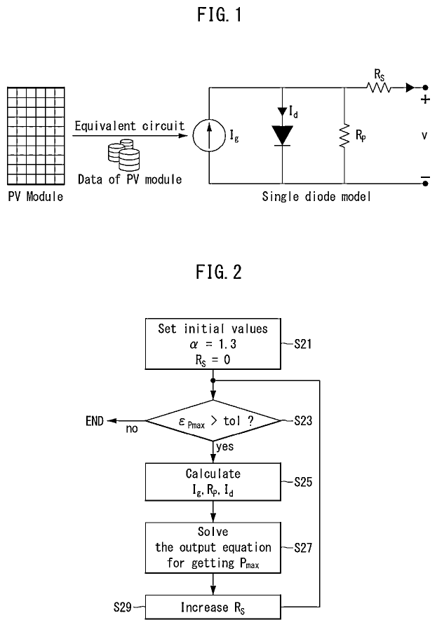

FIG. 1 is a diagram illustrating a photovoltaic (PV) module, which may be applied to a method of estimating PV model parameters, and an electrical equivalent circuit thereof according to one example embodiment of the present disclosure.

In PV modeling, it is important to accurately depict current-voltage (I-V) and power-voltage (P-V) characteristic curves of a real PV module. In particular, the PV modeling is essential especially for PV maximum power point tracking (MPPT) control, operation, and fault diagnosis. Many PV models such as single diode, double diode, and triple diode models are used in the PV modeling. Models with more diodes have higher accuracy, but a structure thereof becomes more complex and the simulation time increases. Thus, in the present disclosure, a single diode model is adopted in consideration of the balance of accuracy and computation time.

Referring to FIG. 1, the equivalent electrical circuit of a single diode model of the PV module, which may be adopted in the PV modeling of the present disclosure, may be confirmed. The single diode model consists of five unknown parameters of a PV current I_{g}, a diode saturation current I_{d}, a diode ideality factor a, a series resistance R_{S}, and a parallel resistance R_{P}, as in the equivalent electrical circuit thereof.

An output equation of the single diode model is given as in Equation 1 below,

$$I = {N}_{PP} \{ {I}_{g} - {I}_{d} [ exp ( \frac{V + {IR}_{S}}{{V}_{t} {N}_{SS}} ) - 1 ] \} - \frac{V + {IR}_{S}}{{R}_{P}} , where {V}_{t} = \frac{a k T}{q} \qquad [ Equation 1 ]$$

In Equation 1 above, N_{SS} and N_{PP} denote the number of cells connected in series and parallel, respectively, Vₜ denotes a thermal voltage, k denotes the Boltzmann constant, T denotes a temperature of the module, and q denotes the electron charge.

Non-linear characteristics of the real PV module may be confirmed in Equation 1, and when estimating parameters, iteration methods are mostly used due to the non-linear characteristics.

FIG. 2 is a flowchart for describing Villalva's method of a comparative example.

First, in the Villalva's method of the comparative example, R_{S} and R_{P} are computed based on the fact that there is only one combination of R_{S} and R_{P}, which ensures that power P_{MPP,model} (hereinafter referred to as first power) of a PV simulation model is equal to power P_{MPP,actual} (hereinafter referred to as second power) of the real PV module, at a maximum power point (MPP). That is, the first power P_{MPP,model}, which is an MPP voltage of the PV simulation model, and the second power V_{MPP,accual}, which is an MPP voltage of a real PV model, are the same at the MPP.

A diode saturation current I_{d} may be obtained from Equation 2 below using data values of an open-circuit voltage V_{OC}, a maximum power voltage V_{MPP} which is an MPP voltage, and a maximum power current I_{MPP} which is an MPP current, which are given in a datasheet of the real PV module.

$${I}_{d} = \frac{{I}_{g} - \frac{{V}_{OC}}{{R}_{P}}}{{e}^{\frac{{V}_{OC}}{{V}_{t}} - 1}} \qquad [ Equation 2 ]$$

In the Villalva's method of the comparative example, a diode ideality factor a is assumed to be 1.3. This value may be changed to any constant for a better model. Thereafter, in order to find the parallel resistance R_{P} at which the first power P_{MPP,model} and the second power P_{MPP,actual} are equal to each other, the series resistance may be computed by expressing the MPP current I_{MPP} as in Equation 3 and using Equation 4 based on Equation 3.

$${I}_{MPP} = {N}_{PP} \{ {I}_{g} - {I}_{d} [ exp ( \frac{{V}_{MPP} + {J}_{MPP} {R}_{S}}{{V}_{t} {N}_{SS}} ) - 1 ] \} - \frac{{V}_{MPP} + {J}_{MPP} {R}_{S}}{{R}_{P}} \qquad [ Equation 3 ]$$

$${R}_{P} = \frac{{V}_{MPP} ( {V}_{MPP} + {I}_{MPP} {R}_{S} )}{{V}_{MPP} [ {N}_{PP} \{ {I}_{g} - {I}_{d} ( exp ( \frac{{V}_{MPP} + {I}_{MPP} {R}_{S}}{{V}_{t} {N}_{SS}} ) - 1 ) \} ] - {P}_{MPP , actual}} \qquad [ Equation 4 ]$$

Equation 4 is established under the assumption that there is only one parallel resistance R_{P}, which allows the simulation model to actually pass the power corresponding to the second power P_{MPP,actual}, for a certain value of the series resistance R_{S}.

In the Villalva's method of the comparative example, it is assumed that the diode saturation current I_{g} and the open circuit current I_{SC} are not equal, and thus a data value of the diode saturation current I_{g} for each iteration is updated using the iteratively obtained values of the series resistance R_{S} and the parallel resistance R_{P}. Thus, the equation for obtaining the diode saturation current I_{g} may be expressed by Equation 6 by first substituting the previously obtained short-circuit current I_{SC} into Equation 1 to obtain Equation 5, and ignoring I_{d} in Equation 5 and rearranging the equation.

$${I}_{S C} = {N}_{PP} \{ {I}_{g} - {I}_{a} [ exp ( \frac{{I}_{SC} {R}_{S}}{{V}_{t} {N}_{SS}} ) - 1 ] \} - \frac{{I}_{SC} {R}_{S}}{{R}_{P}} \qquad [ Equation 5 ]$$

$${N}_{PP} {I}_{g , STC} = \frac{{R}_{P} + {R}_{S}}{{R}_{P}} {I}_{SC , STC} \qquad [ Equation 6 ]$$

Equation 5 described above is for computing the short-circuit current I_{SC}, and Equation 6 is for computing the parallel resistance R_{P} through a relationship between I_{g,STC} and I_{SC,STC} under a standard test condition (STC) by removing I_{d} from Equation 5.

Finally, in order to apply the method of the comparative example as described above to the PV model, initial values of the series resistance R_{S} and the parallel resistance R_{P} should be set. In the method of the comparative example, the initial value of the series resistance R_{S} is 0, and the initial value of the parallel resistance R_{P} is expressed by Equation 7 below.

$${R}_{P , min} = \frac{{V}_{MPP}}{{I}_{S C} - {I}_{MPP}} - \frac{{V}_{OC} - {V}_{MPP}}{{I}_{MPP}} \qquad [ Equation 7 ]$$

In Equation 7, all voltage and current values are values under the STC condition.

A configuration flow of the above-described Villalva's method of the comparative example is illustrated as in FIG. 2.

That is, as shown in FIG. 2, five parameters are first obtained in the Villalva's method. Thereafter, the previously obtained parameters are substituted into Equation 1. In addition, a value of maximum power Pₘₐₓ, that is, the first power P_{MPP,model}, which is the MPP power of the PV simulation model, is obtained while increasing the voltage by a predetermined intensity from 0 to the open-circuit voltage V_{OC}. A power error εPₘₐₓ, which is a difference between the first power P_{MPP,model} at the MPP of the PV simulation model and the second power P_{MPP,actual} at the MPP of the real PV module, may be obtained. The power error may be simply referred to as an error.

Finally, in the Villalva's method, the best five parameters are obtained by iterating the computation until the error εPₘₐ is smaller than a predetermined error.

Meanwhile, a disadvantage may be identified by closely analyzing the method of the comparative example. In particular, since the Villalva's method of the comparative example is satisfied through Equation 4 in which the first power P_{MPP,model} and the second power P_{MPP,actual} are equal to each other, accuracy is confirmed near the MPP. However, the Villalva's method of the comparative example may not be accurate at other points in the P-V curve.

Accordingly, in the present example embodiment, some parameters are computed through an optimization method differently from the Villalva's method of the comparative example, in which the five parameters are obtained only with a mathematical approach.

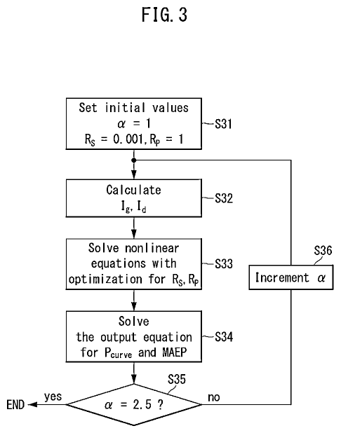

FIG. 3 is a flowchart illustrating a method of estimating PV model parameters according to one example embodiment of the present disclosure.

Referring to FIG. 3, in the method of estimating PV model parameters (hereinafter, simply referred to as a “parameter estimation method”) according to the present example embodiment, first, four different parameters are found while stepwise increasing a diode ideality factor a from 1 to 2.5 as much as a predetermined magnitude in order to overcome the disadvantage of the Villalva's method of the comparative example described above. Thereafter, the parameter estimation method of the present example embodiment is started after setting initial values of R_{S} and R_{P} to 0.001 and 1, respectively. Similar to the Villalva's method, I_{d} and I_{g} may be computed through Equations 2 and 6, respectively.

In order to find R_{S} and R_{P}, three objective functions including R_{S} and R_{P} may be configured. First, two objective functions may be obtained by substituting the diode saturation current I_{d} obtained from Equation 2 into Equations 3 and 5. Thereafter, the final objective function may be obtained using Equation 8 for a characteristic having a slope of 0 at the MPP of the P-V curve.

$$\frac{d P}{d V} {\vert}_{( {V}_{MPP} {J}_{MPP} )} = V \frac{dI}{d V} + I = 0 \qquad [ Equation 8 ]$$

Equation 8 shows that the slope of the P-V curve is 0 at the MPP.

The above-described three objective functions are represented by Equations 9 to 11 below.

$${f}_{1} ( x ) = 0 = {N}_{PP} \{ {I}_{g} - {I}_{d} [ exp ( \frac{{V}_{MPP} + {I}_{MPP} {R}_{S}}{{V}_{t} {N}_{SS}} ) - 1 ] \} - \frac{{V}_{MPP} + {I}_{MPP} {R}_{S}}{{R}_{P}} - {I}_{MPP} \qquad [ Equation 9 ]$$

$${f}_{2} ( x ) = 0 = {N}_{PP} \{ {I}_{g} - {I}_{d} [ exp ( \frac{{I}_{SC} {R}_{S}}{{V}_{t} {N}_{SS}} ) - 1 ] \} - \frac{{I}_{SC} {R}_{S}}{{R}_{P}} - {I}_{SC} \qquad [ Equation 10 ]$$

$${f}_{3} ( x ) = 0 = \frac{{I}_{MPP}}{{V}_{MPP}} - [ \frac{\frac{{I}_{d}}{{V}_{t}} exp ( \frac{{V}_{MPP} + {I}_{MPP} {R}_{S}}{{V}_{t} {N}_{SS}} ) + \frac{1}{{R}_{P}}}{1 + \frac{{R}_{S}}{{R}_{P}} + \frac{{I}_{d} {R}_{S}}{{V}_{t}} exp ( \frac{{V}_{MPP} + {I}_{MPP} {R}_{S}}{{V}_{t} {N}_{SS}} )} ] \qquad [ Equation 11 ]$$

In order to obtain Equation 12 for a third objective function among the three objective functions, Equation 8 may be applied to Equation 1, and V_{MPP} and I_{MPP} may be substituted into Equation 8.

Configuration operations of the above-described parameter estimation method are summarized and shown in the flowchart of FIG. 3.

That is, in the parameter estimation method of the present example embodiment, the five parameters of the PV current I_{g}, the diode saturation current I_{d}, the diode ideality factor a, the series resistance R_{S}, and the parallel resistance R_{P} may be obtained, and then, may be substituted into Equation 1, which is the output equation of the single diode model. At this time, a parameter estimation apparatus implemented by a process, a parameter estimation unit, and the like may set an initial value of the diode ideality factor a to 1, set an initial value of the series resistance R_{S} to a first value, and set an initial value of the parallel resistance R_{P} to a second value (S31). The first value may be 0.001 and the second value may be 1.

Thereafter, the PV current I_{g} and diode saturation current I_{d} may be computed from the output equation of the single diode model using data values of the open-circuit voltage, the MPP voltage, and the MPP current, which are given in a datasheet of the PV module (S32).

Thereafter, a non-linear equation of the single diode model may be computed based on the series resistance R_{S} and the parallel resistance R_{P} that use the computed data value of the diode saturation current I_{d} (S33). According to this operation, the series resistance R_{S} and the parallel resistance R_{P} may be optimized.

Thereafter, a voltage V of the output equation may be increased from 0 to the open-circuit voltage V_{OC}. In addition, when the voltage is 0, the open-circuit voltage, or a specific data value between 0 and the open-circuit voltage, a mean absolute error in power (MAEP) at the output may be computed by comparing third powers P_{curve,model}, which are P-V curve values of the PV obtained from the PV simulation model, with fourth powers P_{curve,actual}, which are the P-V curve values of the real PV module (S34).

At this point, in order to obtain an optimal parameter, a plurality of MAEPs, each of which is obtained each time the diode ideality factor a in the output equation of the single diode model initially set to 1, is increased as much as a predetermined magnitude from 1 to 2.5.

Finally, parameters representing a minimum MAEP among the plurality of stored MAEPs may be selected as parameters of the PV simulation model.

### Comparison Verification

Table 2 illustrates the specifications of a PV module made of the PV simulation model. This may be the same as a list provided by a manufacturer of the real PV module. With reference to this, a PV module simulation model may be generated using MATrix LABoratory (MATLAB)/Simulink. In the present example embodiment, the existing method and the estimation method of the present example embodiment were compared and verified using the PV simulation model provided by MATLAB/Simulink instead of using the real PV module.

TABLE 2

| Rated data | Value | |
|---|---|---|
| Maximum power (P_{MPP, STC}) | 391.6 | W |
| Voltage at maximum power point (V_{MPP, STC}) | 39.6 | V |
| Current at maximum power point (V_{MPP, STC}) | 9.89 | A |
| Open circuit voltate (V_{OC, STC}) | 48 | V |
| Short circuit current (I_{SC, STC}) | 10.51 | A |

| | |
|---|---|
| Temperature coefficient of current (Kᵢ) | 0.023%/° C. |
| Temperature coefficient of voltage (Kᵥ) | −0.26%/° C. |
| The number of cells connected in series (N_{SS}) | 72 |
| The number of cells connected in parallel (N_{PP}) | 1 |

In the comparison verification, characteristic curves were compared. Table 3 below compares estimated results for the parameters of the PV simulation model with respect to the datasheet of Table 2 above. Here, all the parameters are defined under the STC condition, and the MAEP values are computed and compared for both methods of the comparative example (Villalva) and the present example embodiment (proposed).

TABLE 3

| Methods | Villalva | Proposed |
|---|---|---|
| Factor a | 1.3 | 1.0 |
| R_{S} (mΩ) | 82.0 | 275.0 |
| R_{P} (Ω) | 224.0 | 261.4 |
| I_{g} (A) | 10.51 | 10.51 |
| I_{d} (nA) | 16.5 | 0.04 |
| MAEP (W) | 4.75 | 0.34 |

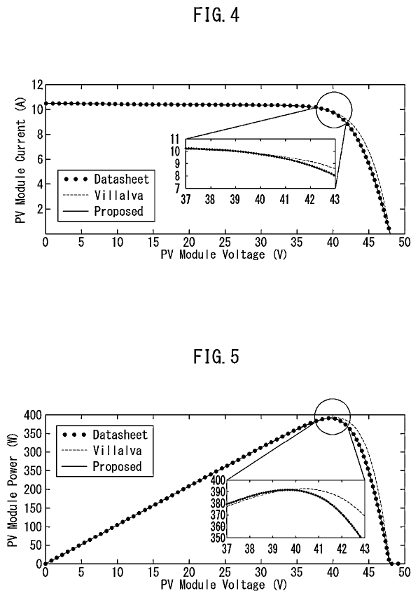

As shown in Table 3, it can be seen that each parameter of the two methods is within physically meaningful values, and it can be seen from the MAEP error that the estimation method of the present example embodiment shows superior performance compared to the existing Villalva's method. The comparison results of Table 3 are represented by PV characteristic curves as shown in FIGS. 4 and 5.

FIG. 4 is a graph showing a comparison between the method (Proposed) of the present example embodiment and the Villalva's method (Villalva) of the comparative example through the I-V characteristic curve of the PV module. In addition, FIG. 5 is a graph showing a comparison between the method (Proposed) of the present example embodiment and the Villalva's method (Villalva) of the comparative example through the P-V characteristic curve of the PV module. In FIGS. 4 and 5, “Datasheet” is an actual data value obtained from the real PV module.

Referring to FIG. 4, it can be seen that all of the method (proposed) of the present example embodiment and the method (Villalva) of the comparative example accurately represent the real PV module in a constant current region (0<V<V_{MPP}) in the I-V characteristic curves of the PV simulation model for the two methods. However, it can be seen that the method of the comparative example has a larger error with respect to the actual value than the method of the present example embodiment in a constant voltage region (V_{MPP}<V<V_{OC}). It is assumed that this is due to the influence of the series resistance R_{S} and the parallel resistance R_{P} among the parameters, and thus it can be seen that the method of the present example embodiment finds parameter values more accurately than the method of the comparative example.

In addition, referring to FIG. 5, in the P-V characteristic curves of the PV simulation model for the two methods, it can be seen that the two methods are accurate in the constant current range but the method of the comparative example shows a larger error than the estimation method of the present example embodiment in the constant voltage region from near the MPP voltage V_{MPP} to the short circuit voltage V_{OC}.

This is because that the method of the comparative example is accurate near the MPP, but has errors in other portions since the parameters were found by assuming that the first power P_{MPP,model} is equal to the second power P_{MPP,actual} of the real PV module. Meanwhile, in the method of the present example embodiment, an error is computed by comparing the first powers P_{curve,model} and P_{curve,actual}, and thus the error is smaller than that of the comparative example in the entire range.

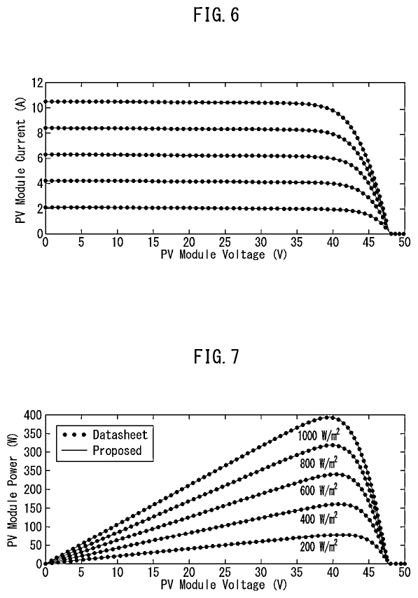

FIG. 6 is a graph showing a comparison between I-V characteristic curves according to the method (Proposed) of the present example embodiment at different solar radiation amounts and actual values of the datasheet. In addition, FIG. 7 is a graph showing a comparison between P-V characteristic curves according to the method (Proposed) of the present example embodiment at different solar radiation amounts and actual values of the datasheet.

Referring to FIGS. 6 and 7, a characteristic curve value of the PV simulation model using the parameter estimation method of the present example embodiment and an actual datasheet value obtained under various solar radiation amount conditions at 25° C. may be compared. Five types of solar radiation amount conditions, 200, 400, 600, 800, and 1000 W/m², were applied.

As shown in FIG. 6, it can be seen that, according to the parameter estimation method of the present example embodiment, I-V characteristic curves that match the actual values are obtained under all solar radiation amount conditions. In addition, as shown in FIG. 7, it can be confirmed that, according to the estimation method of the present example embodiment, the P-V characteristic curves of the PV simulation model exactly match the actual values under all five solar radiation amount conditions. As described above, it can be seen that the parameter estimation method according to the present example embodiment represents the actual data value of the real PV module well under all solar radiation amount conditions as well as under the STC condition.

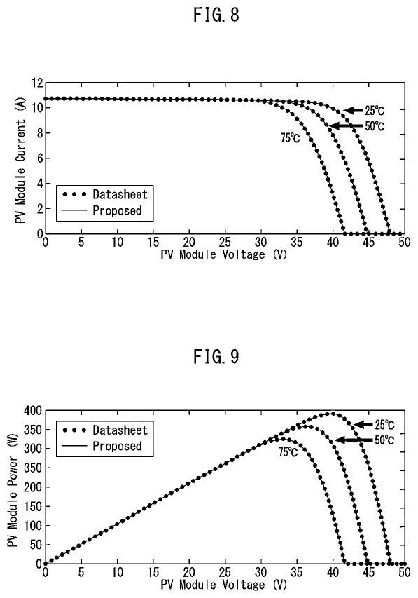

FIG. 8 is a graph showing a comparison between I-V characteristic curves according to the method (Proposed) of the present example embodiment at different temperatures and actual values of the datasheet. In addition, FIG. 9 is a graph showing a comparison between P-V characteristic curves according to the method (Proposed) of the present example embodiment at different temperatures and actual values of the datasheet.

Referring to FIGS. 8 and 9, a characteristic curve value of the PV simulation model generated using the estimation method of the present example embodiment and an actual datasheet value in various temperature conditions at 1000 W/m² may be compared. The simulation model was verified under three conditions of 25° C., 50° C., and 75° C.

According to the estimation method of the present example embodiment, as shown in FIG. 8, it can be seen that the actual values for the I-V characteristics of the datasheet at all temperature conditions and the I-V characteristic curve acquired through the simulation model using the estimation method of the present example embodiment accurately depicts the real PV even under various solar radiation amount conditions. In addition, as shown in FIG. 9, it can be confirmed that the simulation model generated through the estimation method of the present example embodiment exactly matches the actual value for the P-V characteristic of the datasheet in the various temperature conditions.

In conclusion, the parameter estimation method of the present example embodiment may accurately depict the real PV module even under various solar radiation amount and temperature conditions.

The most important thing in generating a simulation model-based PV fault diagnosis algorithm is to generate an accurate PV simulation model. The parameter estimation method of the present example embodiment may more accurately find five unknown parameters than the existing method using a non-linear optimization technique based on a single diode model. In addition, parameters showing a minimum error, which are obtained after iteratively computing the MAEP using the simulation model and the P-V characteristic curve values of the real PV module, may be selected.

The accuracy of the parameter estimation method of the present example embodiment was confirmed through the comparison with the method of the comparative example. That is, it can be seen that both the method of the comparative example and the method of the present example embodiment are accurate in the constant current region (0<V<V_{MPP}), but the method of the present example embodiment is more excellent than the method of the comparative example in the constant voltage region (0<V<V_{OC}). In addition, it is confirmed that the simulation model of the present example embodiment matches the real PV even when the solar radiation amount and the temperature change. Accordingly, an effective parameter estimation method may be provided, and a simulation data-based fault detection and diagnosis algorithm may be provided using the parameter estimation method.

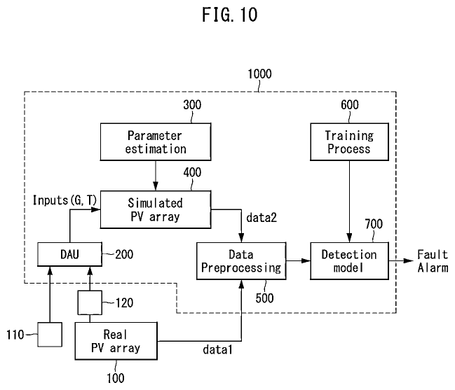

FIG. 10 is a schematic diagram for describing a configuration of a data-based PV fault detection and diagnosis apparatus (hereinafter, simply referred to as a “fault detection apparatus”) using a PV simulation model according to another example embodiment of the present disclosure.

Referring to FIG. 10, a fault detection apparatus 1000 may include a detection model 700 in a narrow sense. The detection model 700 may be constructed on the basis of a convolution neural network (CNN) model, more specifically, a deep neural network (DNN) model, and preferably, a simplified DenseNet model. In addition, the detection model 700 may be connected to a training process providing unit 600 that provides a preset training process. The training process providing unit 600 may also be included in the fault detection apparatus 1000. The detection model 700 may be trained by a preset training process, and may output a PV fault detection and diagnosis result for an input data set as a fault alarm or the like.

In addition, the fault detection apparatus 100 may further include a data preprocessing unit 500 that provides the data set to the detection model 700. The data preprocessing unit 500 may receive first data data1 corresponding to actual data values of a real PV array 100. The first data data1 includes actual I-V curve data, and may be acquired from a real PV module including the real PV array 100 in real time, or may be acquired from a separate data storage for storing data after receiving the data from sensors 110 and 120 that are coupled to the real PV module. Further, the data preprocessing unit 500 may receive simulated I-V curve data from a simulation model 400 as second data data2. In addition, the data preprocessing unit 500 may be configured to process the actual I-V curve data and the simulated I-V curve data through a preset preprocessing procedure, and provided the data set obtained through the processing to the detection model 700.

In addition, the fault detection apparatus 1000 may further include the simulated PV array 400 as at least apart of the PV simulation model. The simulated PV array 400 may generate I-V curve data simulated through the simulation model, to which parameters provided through a parameter estimation unit 300 are applied, using data values for a solar radiation amount G and a temperature T of the real PV array 100 as inputs. The parameter estimation unit 300 may be included in the fault detection apparatus 1000 in a broad sense.

The parameter estimation unit 300 may include a means for selecting five parameters through the parameter estimation method described above with reference to FIG. 3 or a component for performing a function corresponding to the means. The parameter estimation unit 300 may be implemented using a processor or a controller.

In addition, the fault detection apparatus 1000 may further include a data acquisition unit (DAU) 200 that provides the data values of the solar radiation amount and the temperature of the real PV array 100 to the PV simulation model. The DAU 200 may be connected to the first sensor 110 and the second sensor 120 coupled to the real PV array 100. The first sensor 110 is a sensor configured to measure the solar radiation amount of the real PV array 100, and the second sensor 120 may be a sensor for measuring the temperature of the real PV array 100.

According to the present example embodiment, the fault detection apparatus 1000 may effectively detect and diagnose a fault of the real PV array 100 on the basis of simulation data of the simulated PV array 400 by obtaining actual I-V characteristic curve data and simulated I-V characteristic curve data corresponding to the input values of the solar radiation amount and the temperature through the real PV array 100, which is a real PV facility for which it needs to be determined whether there is a fault, and a simulation model that depicts the real PV array 100 by performing a simplified DenseNet-based PV fault detection and diagnosis algorithm, and preprocessing these two pieces of data through a preset preprocessing procedure and inputting the pre-processed two pieces of data to the detection model 700 that is a pre-trained DenseNet-based PV fault diagnosis model.

In addition, the fault detection apparatus 1000 of the present example embodiment may be configured to perform two main priority tasks before detecting and sensing the fault of the PV module. The first of the two tasks is to generate a PV simulation model for generating PV fault data, and the second thereof is to train a DenseNet-based fault diagnosis model. A parameter estimation method for accurately generating the PV simulation model is the same as that in the detailed description provided above with reference to FIG. 3.

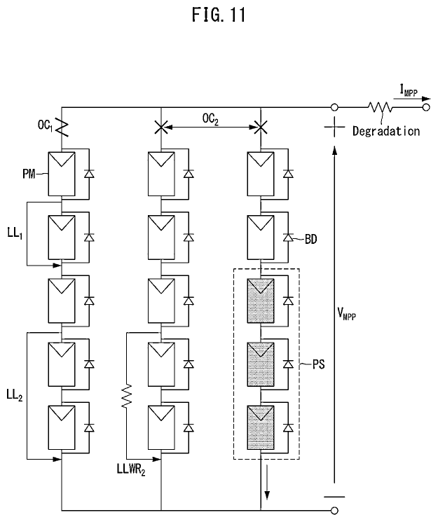

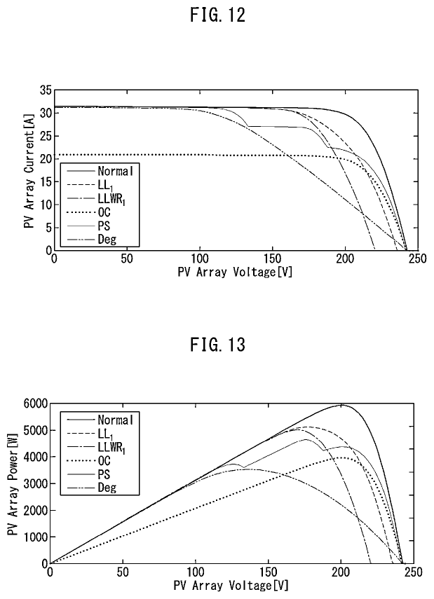

FIG. 11 is a schematic diagram for describing a configuration of a 5×3 PV array testbed of a Matlab/Simulink simulation model, to which the fault detection method of the present example embodiment of FIG. 10 may be applied, and fault types thereof. FIG. 12 is a graph of I-V characteristic curves for describing fault types that may be considered in the fault detection method of the present example embodiment of FIG. 10. In addition, FIG. 13 is a graph of P-V characteristic curves for describing fault types that may be considered in the fault detection method of the present example embodiment of FIG. 10.

Referring to FIG. 11, the PV simulation model may have a configuration of a 5×3 PV array testbed. That is, the testbed may have a structure, in which five PV modules PM are connected in series to form one string and a total of three strings are connected in parallel. A bypass diode BD of each of the PV modules PM is represented in a form attached in parallel to the PV module at a side thereof. The PV simulation model and fault data thereof may be configured to perform programming in a block diagram environment for simulation and design, in consideration of data of a predetermined PV panel for the simulation. In the block diagram environment, Simulink may be used for multi-domain simulation and model-based design.

Simulink may support system level design, simulation, automatic code generation, and continuous testing and verification of an embedded system, and may provide a graphical editor for dynamic system modeling and simulation, and a user definable block library and solver. In addition, Simulink may be integrated with MATLAB, which is a kind of software that provides a numerical analysis and programming environment. In this case, Simulink may incorporate the MATLAB algorithm into the model and export a simulation result to MATLAB for further analysis. In the following description, Simulink described above will be simply referred to as MATLAB/SIMULINK.

In the testbed of Simulink, an open circuit (OC) fault among the PV fault types is an open fault of the string, and the fault may be generated by opening the string in MATLAB/Simulink. The subscript indicates the number of open strings. A line-to-line (LL) fault is a fault in which the PV module is short-circuited, and in this case, the simulated PV module is short-circuited in MATLAB/Simulink. The subscript indicates the number of short-circuited modules. When resistance is present in the short circuit, the corresponding LL fault becomes an LL with resistance (LLWR) fault. A partial shading (PS) fault is a fault that occurs when solar radiation amounts of some modules are different due to clouds or trees. The PS fault may be made by allowing the simulation modules to have different solar radiation amounts. Finally, a degradation fault (DF) occurs when the photovoltaic module itself is worn or damaged, and may be generated by attaching a resistor to the PV array output terminal in the simulation.

I-V characteristic curves of the above-described PV fault types are exemplified as illustrated in FIG. 12. In addition, P-V characteristic curves of the PV fault types described above are exemplified as illustrated in FIG. 13. Referring to FIGS. 12 and 13, a normal characteristic curve and each characteristic curve of each of the fault types of LL₁, LLWR₁, OC, PS, and Deg may compared and confirmed.

When such a testbed is used, a maximum power voltage VV_{MPP} and a maximum power current IV_{MMP} in normal and fault conditions may be obtained by applying various fault scenarios of Table 1 to the testbed (see FIG. 11).

Next, a method of detecting and diagnosing a fault of the PV array panel of the present example embodiment will be described. First, a data preprocessing process will be described, and used fault data types will be described. Thereafter, a simplified DenseNet model will be described, and then a model training process will be described.

The above-described fault types of the simulation model and the fault conditions obtained from the real PV are shown in Table 4.

TABLE 4

| | Targeted values | |
|---|---|---|
| Parameters | Simulated data | Actual data |
| Irradiance | 200 to 1000 W/M², | 200 to 1000 W/M², |
| | at a step change of 25. | at a step change of 24. |
| Temperature | −10 to 60° C., | −7 to 56° C., |
| | at a step change of 5. | at a step change of 7. |
| Percentage | 20% to 80%, | 20% to 80%, |
| Mismatch (LLF) | at a step change of 20. | at a step change of 20 |
| Fault Impedance | 1 to 5Ω, | with 2Ω |
| in Deg. | at a step change of 2. | 2, 4Ω |
| Gain of Partial | PS1: 0.5 | PS1: 0.7 |
| Shading | PS2: 0.2, 0.6 | PS2: 0.35, 0.55 |
| | PS3: 0.5, 0.6, 0.9 | PS3: 0.4, 0.6, 0.8 |
| Number of Dataset | 6,435 Samples | 2,400 Samples |
| | (300 Values/1 Sample) | (300 Values/1 Sample) |

Table 4 illustrates the fault conditions of the simulation model and the fault conditions obtained from the real PV. Data obtained from the real PV may be past fault data of real PV facilities.

As shown in Table 4, fault data may be extracted while variously changing a fault type, a solar radiation amount, a temperature, an impedance, or the like in the simulation model. There is no overlapping fault condition between the extracted simulation data and the actual data, and the number of pieces of simulation data and the number of pieces of the actual data are 6,435 and 2,400, respectively.

TABLE 5

| Fault type | Number of the simulated data | Number of the actual data |
|---|---|---|
| Normal | 495 | 200 |
| OC | 990 | 400 |
| LL/LLWR | 1980 | 800 |
| Deg. | 1485 | 400 |
| PS | 1485 | 600 |

Table 5 illustrates the number of pieces of fault data according to the fault type. The simulated data may be represented by 495 pairs of a solar radiation amount and a temperature because solar radiation amount and temperature conditions are different. That is, one type is reflected in a normal state, and two types of OC₁ and OC₂ may be reflected in the OC fault state. In the case of the LL fault, four types of LL₁, LL₂, LL₃, and LL₄ are possible, but in the simulated data of the present example embodiment, only the LL₁ fault and the LL₂ fault are exemplified. The LLWR fault is present only in the actual fault data. In the case of the degradation fault (DF or Deg), at least one of a total of three types in which resistance values are set to 1, 3, and 5Ω may be reflected, and in the case of the PS fault, the number of the PV modules covered with partial shading may be selected and applied.

In the case of the actual data, a total of 200 conditions for the pair of the solar radiation amount and the temperature may be applied. In the case of the OC fault, there are two types in the actual data, and in the LLWR fault, there are four types in total. In the case of the DF, a total of two types in which resistance values are set to 2Ω and 4Ω may be reflected together or selectively, and in the case of the PS fault, three types may be implemented differently from the simulation data.

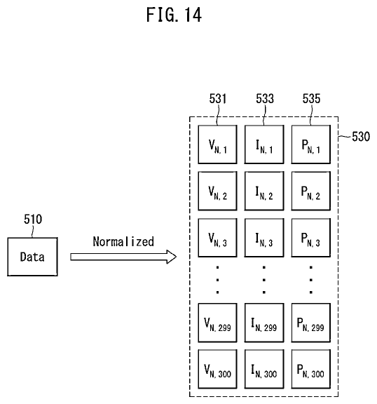

FIG. 14 is a graph for describing a data preprocessing process that may be applied to the fault detection method of the present example embodiment of FIG. 10.

Referring to FIG. 14, in the data preprocessing process, a process of converting a voltage, current, and power obtained from each of the real PV module and the simulated PV model into two-dimensional inputs in order to use them as inputs of the simplified DenseNet-based detection model may be performed.

That is, in the data preprocessing process, the voltage, current, and power, which constitute data 510 of the real PV array, may be normalized to a steady-state open-circuit voltage V_{OC,Normal}, a steady-state short-circuit current I_{SC,Normal}, and a steady-state maximum power P_{MPP,Normal}, respectively. The normalized values are arranged in a two-dimensional matrix 530 and used for training and test data of the detection model. The detection model may be referred to as a fault diagnosis model or a fault detection and diagnosis model.

The normalized values may include a normalized voltage V_{N} (531), a normalized current I_{N} (533), and a normalized power P_{N} (535). The normalized voltage V_{N} may correspond to a value obtained by dividing the voltage V of the real PV module, which is included in the data 510 input to the data preprocessing unit, by the steady-state open-circuit voltage V_{OC,Normal}, and the normalized current I_{N} may correspond to a value obtained by dividing the current I of the real PV module, which is included in the data 510, by the steady-state short-circuit current I_{SC,Normal}, and the normalized power P_{N} may correspond to a value obtained by dividing the power P of the real PV module, which is included in the data 510, by the steady-state power P_{MPP,Normal} at a maximum power point.

The two-dimensional matrix 530 may have the form of 3 columns×M rows having a first row data set (V_{N,1}, I_{N,1}, and P_{N,1}) to an Mth row data set (V_{N,M}, I_{N,M}, and P_{N,M}). Here, M may be 300, but is not limited thereto.

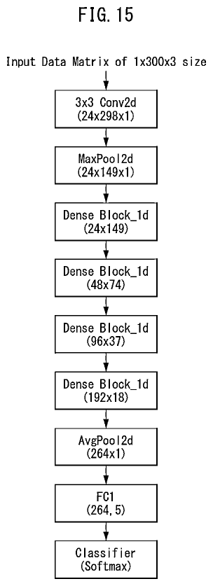

FIG. 15 is a schematic configuration diagram for describing a simplified DenseNet (S_DenseNet) model that may be applied to the fault detection method of the present example embodiment of FIG. 10.

Referring to FIG. 15, the DenseNet model is constructed such that, when passing through layers, a gradient or loss of information is usually regarded as a problem in deep learning. Accordingly, the simplified DenseNet model applied to the fault detection method of the present example embodiment is constructed as a model for addressing both the gradient and loss of information.

Meanwhile, the DenseNet model is usually designed to classify complex images, and thus is too complex to be applied to PV fault data having a small number of features. Accordingly, in the present example embodiment, a layer structure is changed from two-dimensional (2D) to one-dimensional (1D) through a dimensional squeeze to solve a computational efficiency or overfitting problem.

The simplified DenseNet model may receive and process an input data matrix having a size of 1×300×3. In the simplified DenseNet model, the input data matrix is input to a 2D convolution layer Conv2d and processed by the 2D convolution layer Conv2d and then is output through 2D MaxPool MaxPool2d. The layer structure of the input data matrix is changed from 2D to 1D through the dimensional squeeze, and then is changed from 1D to 2D through a plurality of 1D dense blocks Dense Block_1d and a 2D average pool AvgPool2d. Thereafter, the input data matrix may pass through a full connection FC1 and may be output through a classifier such as Softmax.

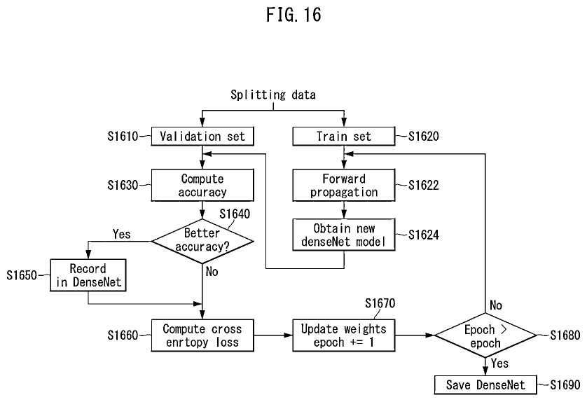

FIG. 16 is a flowchart for a training process of the simplified DenseNet model of FIG. 15.

Referring to FIG. 16, a training process may include generating a validation set of a first ratio from split data that is training data composed of a portion of mixed data (S1610), and generating a training set of a second ratio (S1620). Here, the first ratio may be in a range of 20% to 30%, and preferably, 25%, and the second ratio may be in a range of 80% to 70%, and preferably, 75%.

The split data may be prepared by mixing actual data and simulation data, and preparing a predetermined ratio of the mixed data as training data for training the simplified DenseNet model. The split data may be split data generated by data splitting.

The training set prepared as a portion of the training data composed of a portion of the mixed data may be 80% of the training data, and this ratio may be changed in a range of about ±5% depending on the type of the PV module, an installation place, or the like and applied. The validation set is the remaining data obtained by subtracting the training set from the training data.

Next, the training process may include performing a forward propagation calculation of computing and storing the training set prepared as a portion of the training data, which is split data of the mixed data, in a forward direction along a neural network of various layers (S1622).

Next, the training process may include obtaining a new DenseNet model through the forward propagation calculation (S1624). The new DenseNet model is a type of simplified DenseNet model.

Next, accuracy may be computed by inputting the validation set composed of the remaining training data to the new DenseNet model (S1630).

Next, whether the accuracy of the DenseNet model is further improved is determined (S1640). That is, in the present operation, it may be determined whether the accuracy of the current neural network model is further improved than the accuracy of the previous DenseNet model before iterating the present process.

When the accuracy is further improved, the parameter or setting of the current simplified Dense model may be recorded (S1650). Meanwhile, when the accuracy is not improved, a preset index may be computed (S1660).

The preset index is used to measure how well the simplified DenseNet model performs, and cross entropy loss, binary entropy loss, log loss, and the like may be used therefor. Among them, the cross entropy loss is used to obtain a difference between two probability distributions, and may be used to obtain a difference between the probability distribution of the actual data and the probability distribution computed by the trained model in the simplified DenseNet model.

Thereafter, weights may be updated. In addition, a training number (epoch) may be increased +1 for the next iteration (S1670)

Thereafter, whether a training number (Epoch) increased +1 is greater than a preset maximum training number (epoch) is determined (S1680).

When the increased training number (Epoch) is not greater than the preset maximum training number (epoch), the training set is input to the updated Dense model in which the weight is updated, and the method returns back to performing the forward propagation calculation (“No” in S1680) to iteratively perform subsequent processes.

On the other hand, when the increased training number (Epoch) is greater than the preset maximum training number (epoch), the simplified DenseNet model finally obtained from the present training process may be stored (S1690).

The above-described training process may be performed by a processor. The processor may be mounted on an apparatus for estimating the parameters of the PV model or the data-based PV fault detection and diagnosis apparatus using the PV model.

According to the above-described configuration, in the training process of the simplified DenseNet model, data in which the actual data and the simulation data are mixed is split into 20% test data and 80% training data, and the training data, which is the split data, may be split again into 75% training set and 25% validation set. In addition, accuracy may be computed by training the new DenseNet model with the 75% training set through the forward propagation calculation and verifying the trained DenseNet model with the validation set. In this case, when accuracy is further improved than the training result of the DenseNet model from the previous training, parameters or settings of the trained model are stored, and when accuracy is not improved, a preset index or loss may be computed. In addition, when the present process is iterated by a predetermined number of iterations (epoch), a DenseNet model with the highest accuracy may be obtained. Finally, accuracy may be computed by testing the most accurately trained DenseNet model using 20% test data that is previously split.

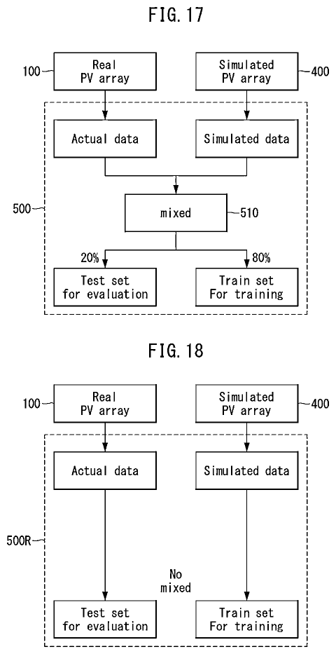

FIG. 17 is a diagram for describing test data that may be applied to the fault detection method of the present example embodiment of FIG. 10. In addition, FIG. 18 is a diagram for describing an effect of unmixed test data, which may be considered in the fault detection method of the present example embodiment of FIG. 10.

Referring to FIG. 17, test data may be prepared when training data is split from the mixed data by the data preprocessing unit or a data splitting unit. The data splitting unit may be mounted on a processor or controller.

Data splitting may refer to mixing actual data obtained in the real PV array 100 and simulated data obtained from the simulated PV array of the simulated PV model 400, and splitting the mixed data to use 20% of the mixed data as test data for evaluation of the trained model and to use the remaining 80% of the mixed data as training data. In addition, the data splitting may be splitting the training data into 75% training set and 25% validation set.

To this end, the fault detection apparatus may include a data mixing unit 510. The data mixing unit 510 may be included in the data preprocessing unit 500, but the present invention is not limited thereto.

As described above, when the actual data and the simulation data are mixed, the mixed data splits into test data and training data, and the training data splits again into a training set and a validation set to be used, since the fault conditions between the actual data and the simulation data are all different, generated errors may be minimized.

Meanwhile, the case in which unmixed test data is used as shown in FIG. 18 may be considered as a comparative example having a data preprocessing unit 500R. That is, the data preprocessing unit 500R may provide the actual data obtained from the real PV array 100 and the simulated data obtained from the simulated PV array of the simulation PV model 400 as inputs of the detection model without mixing at all (Not mixed). In this case, the detection model is trained with the simulated data and tested with the actual data, and here, a relatively large error between the training result and the test result, which is caused by the different fault conditions between the two pieces of data, may occur.

As described above, according to the data splitting of the present example embodiment, a data set input that is effective for PV fault detection and diagnosis may be provided in the simplified DenseNet-based detection model.

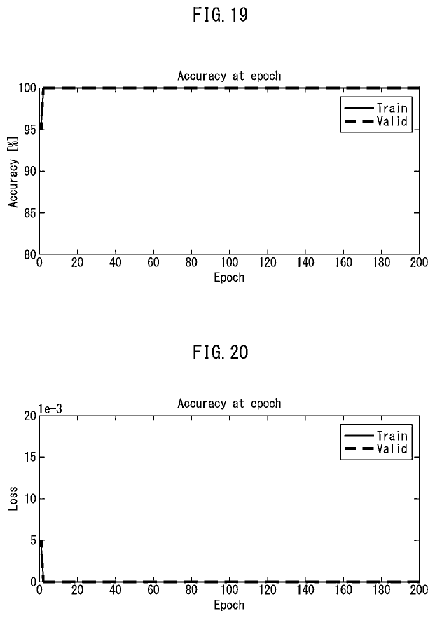

FIG. 19 is a graph illustrating accuracy according to the training number (epoch) of the S_DenseNet model of FIG. 15. FIG. 20 is a graph illustrating losses according to the training number (epoch) of the S_DenseNet model of FIG. 15.

Referring to FIG. 19 and FIG. 20, training results with respect to the simplified DenseNet-based fault diagnosis model may be confirmed. The training results are exemplified as accuracy at epoch and losses at epoch.

As shown in FIG. 19, the accuracy of each of the training data set and the validation data set is computed for each training epoch. The training initially starts with about 95% accuracy and shows 100% accuracy in a short period of time, and shows 100% accuracy consistently throughout the training period.

In addition, as shown in FIG. 20, the loss of each of the training data set and the validation data set is computed every training epoch. Similar to the accuracy, the loss quickly converges to 0.

Through this, it can be seen that the training process of the simplified DenseNet model of the present example embodiment can be performed very quickly and accurately.

TABLE 6

Statistical analysis in 10 random runs

| Accuracy (%) | Max | Min | Mean | Std |
|---|---|---|---|---|
| Training set | 100 | 100 | 100 | 0 |
| Test set | 100 | 100 | 100 | 0 |

Table 6 shows the results obtained by randomly performing data splitting 10 times, and statistically analyzing values obtained by computing the test accuracy of the simplified DenseNet model trained with each of the split data.

As shown in Table 6, after randomly splitting the data, a total of 10 accuracy computations were performed for the training set and the test set. The results show 100% at each of the minimum, maximum, and mean of the accuracies for both the training set and the test set.

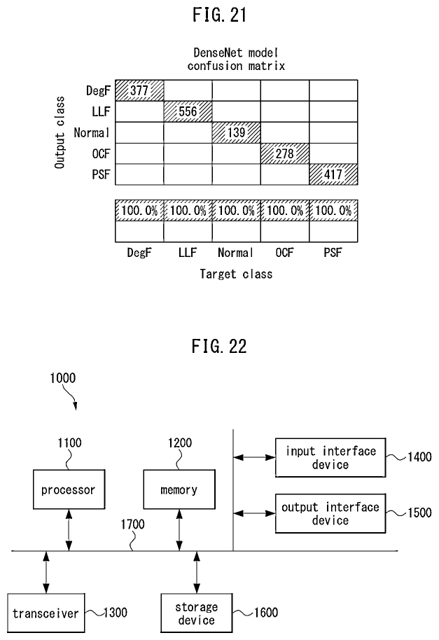

FIG. 21 is a diagram illustrating a confusion matrix of the simplified DenseNet model for the test set.

Referring to FIG. 21, a test result of the simplified DenseNet-based fault diagnosis model may be confirmed. The test result is described with accuracy statistics and a confusion matrix. That is, a confusion matrix of the simplified DenseNet model for the test data set is illustrated. Target class is a result value expressed by the DenseNet model, and Output class is a true value for actual test data.

All fault types of Deg, LLF, Normal, OCF, and PSF of the above-described confusion matrix may be separated fully (see Table 6). As described above, it may be seen that the trained DenseNet-based fault diagnosis model accurately classifies all the faults in both the training set and the test set. Here, the training set may be training data or a training data set, and the test set may be test data or a test data set.

Table 7 shows the results of statistical analysis of processing results of a neural network-based training model for the test data of the present example embodiment (Case1: proposed) using the mixed data of the actual data and the simulation data and the comparative example (Case2: not mixed) in which the two pieces of data are not mixed at all. The present example embodiment shows results obtained by randomly performing data splitting 10 times, and statistically analyzing values obtained by computing the test accuracy of the simplified DenseNet model trained with each of the split data.

TABLE 7

| | Statistical analysis in 10 random runs on the test data | | | |
|---|---|---|---|---|
| Case types | Max | Min | Mean | Std |
| Case 1: Proposed | 100 | 100 | 100 | 0 |
| Case 2: no mixed | 92.37 | 84.2 | 89.06 | 2.67 |

As shown in Table 7, the results of the first case Case1 indicate that the accuracy of the fault detection and diagnosis is 100% at each of the maximum, minimum, and mean of the accuracies. That is, the detection model of the present example embodiment has been trained accurately, and accurately classifies all faults in the test data.

Meanwhile, the second case Case2 does not show 100% accuracy. Case2 shows a maximum accuracy of 92.37%, a minimum accuracy of 84.2%, and a mean accuracy of 89.06%. This means that the accuracy of the unmixed test data may be degraded because the test data not used for the model training, which is actual data, does not match the simulated data, which is training data, in the fault conditions.

Based on these results, it is desirable to train a fault model using data from as many conditions as possible to increase the reliability and accuracy of the PV fault diagnosis model, and in the present example embodiment taking this into consideration, accuracy and speed may be properly balanced using data splitting.

FIG. 22 is a schematic block diagram of a data-based PV fault detection and diagnosis apparatus (hereinafter, simply referred to as a “fault detection apparatus”) using a PV model according to still another example embodiment of the present disclosure.

Referring to FIG. 22, a fault detection apparatus 1000 may include at least one processor 1100. In this case, the at least one processor 1100 may be configured to estimate the parameters of a PV model or handle data-based PV fault detection and diagnosis utilizing the PV model using the estimated parameters.

In addition, the fault detection apparatus 1000 may optionally further include a memory 1200, a transceiver 1300, an input interface device 1400, an output interface device 1500, a storage device 1600, or a combination thereof. Each of the components included in the fault detection apparatus 1000 may be connected by a bus 1700 to communicate with each other.

The processor 1100 may execute program commands stored in at least one of the memory 1200 and the storage device 1600. The program commands may include commands that implement at least some of a procedure for estimating the parameters of the photovoltaic model or a procedure for performing the data-based PV fault detection and diagnosis utilizing the PV model using the estimated parameters. The program commands may be implemented in the form of at least one software module.

The processor 1100 may be a central processing unit (CPU), a graphics processing unit (GPU), or a dedicated processor on which at least one method among the methods according to the example embodiments of the present disclosure is performed.

Each of the memory 1200 and the storage device 1600 may be implemented using at least one of a volatile storage medium and a nonvolatile storage medium. For example, the memory 1200 may be implemented using at least one of a read only memory (ROM) and a random access memory (RAM).

The transceiver 1300 connects a PV system, a PV control system, or a PV management system to a user terminal or an external server through a network, and includes a device for transmitting and receiving a signal and data or a component corresponding to the device. The transceiver 1300 may include at least one sub-communication system for wired, wireless, or satellite communication or a combination thereof.

The input interface device 1400 may include input devices such as a keyboard, a microphone, a touch pad, a touch screen, and the like, and an input signal processing unit configured to map or process at least one selected from among the input devices and a signal input through the at least one input device with a previously stored command and transmit the signal to the processor 1100.

The output interface device 1500 may include an output signal processing unit configured to map or process a signal output according to the control of the processor 1100 to a previously stored signal form or level, and at least one output device configured to output a signal or information in the form of vibrations, light, or the like according to the signal of the output signal processing unit. The at least one output device may include at least one selected from output devices such as a speaker, a display device, a printer, a light output device, a vibration output device, and the like.

The fault detection apparatus 1000 may be used in the form of a personal computer, a web server, a computing server, an application server, a database server, a file server, a game server, a mail server, a proxy server, or a combination thereof, which functions as a communication node. In addition, the fault detection apparatus 1000 may be implemented with at least some functional units of a base station, which is one node of a communication network, or a component that performs functions of the functional unit.

According to the example embodiments described above, the present disclosure may provide a simplified DenseNet-based PV fault detection and diagnosis algorithm. At least four types of PV faults may be diagnosed using a simulation model having a solar radiation amount and a temperature of a real PV array as inputs. That is, I-V and P-V characteristic curves of a PV may be obtained by inputting the solar radiation amount and the temperature, and then fault data for training a fault diagnosis model may be generated. The fault data may be used to train and test a DenseNet model. The results of both the training and the test confirmed that the fault detection and diagnosis algorithm is very fast and accurate.

In addition, according to the present example embodiment, after mixing actual data and simulation data, the mixed data is classified into test data and training data, and the training data is used again for validation data and training data (final training data), so that adverse effects of untrained data on the detection model may be prevented.

In addition, according to the present example embodiment, finally, the proposed PV fault detection and diagnosis algorithm may be sufficiently applied for real PV fault diagnosis using a PV simulation model. That is, a simulation model may be generated using a parameter estimation method, and fault data may be generated to train a simplified DenseNet model. Accordingly, fault diagnosis of a PV facility to be actually applied may be sufficiently performed using past failure data of a related actual PV facility even in a state in which an actual photovoltaic facility is not provided.

According to the above-described configuration of the present disclosure, a fault of a photovoltaic system may be detected and diagnosed using the simplified DenseNet model without manually extracting fault features.

In addition, the parameters of a PV model with good performance may be effectively estimated by implementing a single diode model corresponding to the PV system with a simulation model such as MATLAB/Simulink, and extracting and preprocessing PV data using the implemented PV simulation model and then training and testing the simplified DenseNet model, and a high-efficiency and high-performance data-based PV fault detection and diagnosis algorithm may be provided by a photovoltaic model using the estimated parameters.

In addition, a hybrid parameter estimation method may be provided as a PV fault detection and diagnosis method having superior performance as compared to Villalva's method, which is one of the existing methods.

In addition, it may be confirmed that the present example embodiment has excellent effects in detecting and diagnosing PV faults as a result of comparing the performance of the MATLAB/Simulink simulation model of the present example embodiment with existing methods using I-V characteristic curves and P-V characteristic curves of the PV array, which are obtained while changing the solar radiation amount and the temperature for the PV module.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of estimating photovoltaic (PV) model parameters that is performed by a processor, the method comprising:
substituting five parameters of a PV current, a diode saturation current, a diode ideality factor, a series resistance, and a parallel resistance into an output equation of a single diode model for PV modeling of a PV module;
stepwise increasing and applying a voltage of the output equation as much as a preset intensity from 0 to an open-circuit voltage;
computing a mean absolute error in power (MAEP) in an output by comparing power-voltage (P-V) curve values of the PV module obtained from the single diode model, which is a PV simulation model, and P-V curve values of the PV module, which is an actual PV module, when the voltage is zero, the open-circuit voltage, or a specific data value increased as much as a preset intensity; and
selecting parameters representing a minimum MAEP among a plurality of stored MAEPs as parameters of the PV simulation model.

2. The method of claim 1, wherein, in the substituting of the five parameters,
an initial value of the diode ideality factor is set to 1,
an initial value of the series resistance is set to 0.001, and
an initial value of the parallel resistance is set to 1.

3. The method of claim 2, further comprising computing a maximum power point current and a diode saturation current from the output equation of the single diode model using data values of an open-circuit voltage, a maximum power point voltage, and a maximum power point current given in a datasheet of the PV module.

4. The method of claim 3, further comprising computing a non-linear equation of the single diode model on the basis of the series resistance and the parallel resistance using the computed data value of the diode saturation current.

5. The method of claim 4, wherein, in the computing of the MAEP, a plurality of MAEPs are computed by stepwise increasing the diode ideality factor, which is initially set to a first value, up to a second value as much as a predetermined magnitude according to the increase in the voltage, and stored.

6. The method of claim 5, wherein the first value is 1, and the second value is 2.5.

7. A data-based photovoltaic (PV) fault detection and diagnosis apparatus using a PV model, the apparatus comprising:
a data preprocessing unit configured to receive actual current-voltage (I-V) characteristic curve data according to a solar radiation amount and a temperature of a real PV array, and receive simulated I-V characteristic curve data obtained by inputting the solar radiation amount and the temperature into a simulation model in which five parameters required for analysis of an equivalent electrical circuit of a single diode model for modeling the real PV array are reflected; and
a detection model configured to process a data set input from the data preprocessing unit according to a predetermined training process to detect a type of a fault of the real PV array,
wherein the data preprocessing unit classifies training data, which is a portion of mixed data obtained by mixing the actual I-V characteristic curve data and the simulated I-V characteristic curve data, into a validation set and a training set according to a preset ratio and provides the validation set and the training data to the detection model.

8. The apparatus of claim 7, wherein the data preprocessing unit includes a data mixing and splitting unit,
wherein the data mixing and splitting unit mixes the actual I-V characteristic curve data with the simulated I-V characteristic curve data, splits the mixed data into training data and test data, and splits the training data into a validation set for the detection model and a training set for the detection model.

9. The apparatus of claim 7, further comprising a parameter estimation unit configured to provide the five parameters to the simulation model,
wherein the parameter estimation unit is configured to perform:
substituting five parameters of a PV current, a diode saturation current, a diode ideality factor, a series resistance, and a parallel resistance into an output equation of a single diode model for PV modeling of a PV module;
stepwise increasing a voltage of the output equation as much as a preset intensity from 0 to an open-circuit voltage;
computing a mean absolute error in power (MAEP) in an output by comparing power-voltage (P-V) curve values of the PV module obtained from the single diode model, which is a PV simulation model, and P-V curve values of the PV module, which is an actual PV module, when the voltage is zero, the open-circuit voltage, or a specific data value increased as much as a preset intensity; and
selecting parameters representing a minimum MAEP among a plurality of stored MAEPs as parameters of the PV simulation model.

10. The apparatus of claim 9, wherein, in the substituting of the five parameters, the parameter estimation unit sets an initial value of the diode ideality factor to 1, sets an initial value of the series resistance to 0.001, and sets an initial value of the parallel resistance to 1.

11. The apparatus of claim 10, wherein the parameter estimation unit is configured to further perform computing a maximum power point current and a diode saturation current from the output equation of the single diode model using data values of an open-circuit voltage, a maximum power point voltage, and a maximum power point current given in a datasheet of the PV module.

12. The apparatus of claim 11, wherein the parameter estimation unit is configured to further perform computing a non-linear equation of the single diode model on the basis of the series resistance and the parallel resistance using the computed data value of the diode saturation current.

13. The apparatus of claim 12, wherein the parameter estimation unit is configured to compute and store a plurality of MAEPs by stepwise increasing the diode ideality factor, which is initially set to a first value, up to a second value as much as a predetermined magnitude according to the increase of the voltage in the computing of the MAEP.

14. The apparatus of claim 13, wherein the first value is 1, and the second value is 2.5.

15. The apparatus of claim 7, wherein the training process includes:
performing a forward propagation calculation of computing and storing the training set in a forward direction along a neural network of various layers;
computing accuracy by inputting data of the validation set to a DenseNet model to which parameters obtained through the forward propagation calculation are applied; and
storing parameters or settings in a current DenseNet model when the accuracy is further improved.

16. The apparatus of claim 15, wherein the training process further includes computing a preset index when the accuracy is not improved,
wherein the index includes at least one of cross entropy loss, binary entropy loss, and log loss.

17. The apparatus of claim 16, wherein the training process further includes updating a weight with a preset value, performing the forward propagation calculation up to a preset maximum number of iterations, computing the accuracy, and storing parameters or settings according to a result of the determination of the accuracy or iterating the computing of the preset index.

18. A data-based photovoltaic (PV) fault detection and diagnosis method using a PV model, the method comprising:
receiving actual current-voltage (I-V) characteristic curve data according to a solar radiation amount and a temperature of a real PV array;
receiving data values of five parameters used in an equivalent electrical circuit of a single diode model obtained by modeling the real PV array;
generating simulated I-V characteristic curve data by inputting the solar radiation amount and the temperature to a simulation model to which the data values of the five parameters are reflected;
mixing the actual I-V characteristic curve data and the simulated I-V characteristic curve data, splitting the mixed data into training data and test data, and splitting the training data into a validation set for a detection model and a training set for the detection model; and
detecting a fault type of the real PV array by processing the training set and the validation set according to a predetermined training process.

19. The method of claim 18, further comprising estimating the parameters,
wherein the estimating of the parameters includes:
substituting five parameters of a PV current, a diode saturation current, a diode ideality factor, a series resistance, and a parallel resistance into an output equation of a single diode model for PV modeling of a PV module;
stepwise increasing a voltage of the output equation as much as a preset intensity from 0 to an open-circuit voltage;
computing a mean absolute error in power (MAEP) in an output by comparing power-voltage (P-V) curve values of the PV module obtained from the single diode model, which is a PV simulation model, and P-V curve values of the PV module, which is an actual PV module, when the voltage is zero, the open-circuit voltage, or a specific data value increased as much as a preset intensity; and
selecting parameters representing a minimum MAEP among a plurality of stored MAEPs as parameters of the PV simulation model.

20. The method of claim 19, wherein in the substituting of the five parameters,
an initial value of the diode ideality factor is set to 1, an initial value of the series resistance is set to 0.001, and an initial value of the parallel resistance is set to 1,
the method further comprises:
computing a maximum power point current and a diode saturation current from the output equation of the single diode model using data values of an open-circuit voltage, a maximum power point voltage, and a maximum power point current given in a datasheet of the PV module; and
computing a non-linear equation of the single diode model on the basis of the series resistance and the parallel resistance using the computed data value of the diode saturation current, and
in the computing of the MAEP, a plurality of MAEPs are computed by stepwise increasing the diode ideality factor, which is initially set to a first value, up to a second value as much as a predetermined magnitude according to the increase of the voltage, and stored.
